(19) United States
(12) Patent Application Publication
(10) Pub. No.: US 2017/0053413 A1
(43) Pub. Date: Feb. 23, 2017

(54) METHOD, APPARATUS, AND COMPUTER PROGRAM PRODUCT FOR PERSONALIZED STEREOSCOPIC CONTENT CAPTURE WITH SINGLE CAMERA END USER DEVICES

(71) Applicant: Nokia Technologies OY, Espoo (FI)

(72) Inventors: Sujeet Shyamsundar Mate, Tampere (FI); Kimmo Tapio Roimela, Tampere (FI)

(21) Appl. No.: 14/829,175

(22) Filed: Aug. 18, 2015

(51) Int. Cl. G06T 7/00; G06F 3/01; H04N 13/02; H04N 5/232

(52) U.S. Cl. CPC G06T 7/0075; G06T 7/0081; H04N 5/23238; G06F 3/011; H04N 13/021; G06T 2207/10021; G06T 2207/10028; G06T 2207/30244

(57) ABSTRACT

A method, apparatus, and computer program product are provided for providing personalized depth of field perception for omnidirectional video. A method is provided that includes generating, by a processor, a three-dimensional reconstruction of content from an omnidirectional capture device; determining a camera pose of an end user device in relation to the omnidirectional capture device content; identifying an object of interest in the content based in part on the camera pose of the end user device; generating an artificial depth of field for the content wherein the object of interest is in focus; and causing a personalized content view to be provided based on the object of interest and the artificial depth of field. A corresponding apparatus and a computer program product are also provided.

### TECHNOLOGICAL FIELD

An example embodiment of the present invention relates generally to immersive content capture, and more specifically, to stereoscopic content capture with end user devices.

### BACKGROUND

Immersive content capture devices are increasingly becoming common, providing content (e.g., 360 panoramas, spherical videos) designed for use with various immersive content consumption devices, such as virtual reality (VR) devices. In addition, Omnidirectional Content Capture (OCC) type of devices are becoming more common. Some OCC devices can be equipped with stereoscopic cameras. These types of devices can be used to capture immersive content (IC). However, even today, a vast majority of end user devices are two-dimensional (2D) video capture devices. Embodiments of the present invention are directed to utilization of such OCC devices in events (such as concerts, sports, social events, casual events, etc.) in combination with end user devices for enhanced content capture experiences.

### BRIEF SUMMARY

Methods, apparatuses, and computer program products are therefore provided according to example embodiments of the present invention to provide personalized stereoscopic content capture.

In one embodiment, a method is provided that at least includes receiving data corresponding to content capture from an end user device; receiving one or more omnidirectional content feeds; determining, by a processor, a camera pose estimate for the end user device in relation to one or more omnidirectional content capture devices providing the one or more omnidirectional content feeds, based in part on the data corresponding to content capture; selecting one of the one or more omnidirectional content capture devices as a buddy device for the end user device based at least in part on the camera pose estimate; extracting, from the selected buddy device content feed, a matching region of interest corresponding to end user device content capture; selecting a virtual stereo view and generating virtual stereo view metadata based on the extracted matching region of interest; and generating personalized stereoscopic content for the end user device based on virtual stereo view content from the buddy device and content captured by the end user device.

In some embodiments, the data corresponding to content capture from an end user device comprises one or more of: one or more video frames; one or more types of sensor data; audio data; or temporal synchronization data. In some embodiments, the types of sensor data comprise one or more of: GPS data; indoor positioning system data; compass data; accelerometer data; or gyroscope data.

In some embodiments, the method further comprises selecting one of the one or more omnidirectional content capture devices as a buddy device based on one of user requirements or default requirements.

In some embodiments, selecting one of the one or more omnidirectional content capture devices as a buddy device based on user requirements comprises receiving an indication of an object of interest.

In some embodiments, selecting one of the one or more omnidirectional content capture devices as a buddy device based on user requirements comprises receiving an indication of a range for stereoscopic content capture. In some embodiments, the range for stereoscopic content capture may be a high range, medium range, or low range; and wherein indications of corresponding objects of interest for each range may be provided.

In some embodiments, selecting one of the one or more omnidirectional content capture devices as a buddy device based on default requirements comprises using an ideal baseline distance.

In some embodiments, selecting one of the one or more omnidirectional content capture devices as a buddy device based on default requirements comprises using an ideal angle between the end user device and the omnidirectional content capture device.

In another embodiment, an apparatus is provided that includes at least one processor and at least one memory including computer program instructions, the at least one memory and the computer program instructions, with the at least one processor, causing the apparatus at least to: receive data corresponding to content capture from an end user device; receive one or more omnidirectional content feeds; determine a camera pose estimate for the end user device in relation to one or more omnidirectional content capture devices providing the one or more omnidirectional content feeds; select one of the one or more omnidirectional content capture devices as a buddy device for the end user device based at least in part on the camera pose estimate; an artificial depth of field for the content wherein the object of interest is in focus; and extract, from the selected buddy device content feed, a matching region of interest corresponding to end user device content capture; select a virtual stereo view and generate virtual stereo view metadata based on the extracted matching region of interest; and generate personalized stereoscopic content for the end user device based on virtual stereo view content from the buddy device and content captured by the end user device.

In some embodiments, the data corresponding to content capture from an end user device comprises one or more of: one or more video frames; one or more types of sensor data; audio data; or temporal synchronization data. In some embodiments, the types of sensor data comprise one or more of: GPS data; indoor positioning system data; compass data; accelerometer data; or gyroscope data.

In some embodiments, the apparatus further comprises the at least one memory and the computer program instructions, with the at least one processor, causing the apparatus at least to select one of the one or more omnidirectional content capture devices as a buddy device based on one of user requirements or default requirements.

In some embodiments, selecting one of the one or more omnidirectional content capture devices as a buddy device based on user requirements comprises receiving an indication of an object of interest.

In some embodiments, selecting one of the one or more omnidirectional content capture devices as a buddy device based on user requirements comprises receiving an indication of a range for stereoscopic content capture. In some embodiments, the range for stereoscopic content capture may be a high range, medium range, or low range; and wherein indications of corresponding objects of interest for each range may be provided.

In some embodiments, selecting one of the one or more omnidirectional content capture devices as a buddy device based on default requirements comprises using an ideal baseline distance.

In some embodiments, selecting one of the one or more omnidirectional content capture devices as a buddy device based on default requirements comprises using an ideal angle between the end user device and the omnidirectional content capture device.

In another embodiment, a computer program product is provided comprising at least one non-transitory computer-readable storage medium bearing computer program instructions embodied therein for use with a computer, the computer program instructions comprising program instructions, when executed, causing the computer at least to: receive data corresponding to content capture from an end user device; receive one or more omnidirectional content feeds; determine a camera pose estimate for the end user device in relation to one or more omnidirectional content capture devices providing the one or more omnidirectional content feeds; select one of the one or more omnidirectional content capture devices as a buddy device for the end user device based at least in part on the camera pose estimate; an artificial depth of field for the content wherein the object of interest is in focus; and extract, from the selected buddy device content feed, a matching region of interest corresponding to end user device content capture; select a virtual stereo view and generate virtual stereo view metadata based on the extracted matching region of interest; and generate personalized stereoscopic content for the end user device based on virtual stereo view content from the buddy device and content captured by the end user device.

In some embodiments, the data corresponding to content capture from an end user device comprises one or more of: one or more video frames; one or more types of sensor data; audio data; or temporal synchronization data. In some embodiments, the types of sensor data comprise one or more of: GPS data; indoor positioning system data; compass data; accelerometer data; or gyroscope data.

In some embodiments, the computer program product further comprises program instructions, when executed, causing the computer at least to select one of the one or more omnidirectional content capture devices as a buddy device based on one of user requirements or default requirements.

In some embodiments, selecting one of the one or more omnidirectional content capture devices as a buddy device based on user requirements comprises receiving an indication of an object of interest.

In some embodiments, selecting one of the one or more omnidirectional content capture devices as a buddy device based on user requirements comprises receiving an indication of a range for stereoscopic content capture. In some embodiments, the range for stereoscopic content capture may be a high range, medium range, or low range; and wherein indications of corresponding objects of interest for each range may be provided.

In some embodiments, selecting one of the one or more omnidirectional content capture devices as a buddy device based on default requirements comprises using an ideal baseline distance.

In some embodiments, selecting one of the one or more omnidirectional content capture devices as a buddy device based on default requirements comprises using an ideal angle between the end user device and the omnidirectional content capture device.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates a block diagram of an apparatus that may be specifically configured in accordance with an example embodiment of the present invention;

FIG. 2A illustrates an example of embodiment of a stereoscopic content capture system implementation in accordance with an example embodiment of the present invention;

FIG. 2B illustrates an example embodiment of a stereoscopic content capture system implementation in accordance with an example embodiment of the present invention;

FIG. 3A illustrates an example thin client architecture in accordance with an example embodiment of the present invention;

FIG. 3B illustrates an example thick client architecture in accordance with an example embodiment of the present invention;

FIG. 4 provides a flow chart illustrating buddy device selection in accordance with an example embodiment of the present invention;

FIG. 5 provides a flow chart illustrating virtual stereo view selection in accordance with an example embodiment of the present invention; and

FIG. 6 provides a flow chart of example operations for providing personalized stereoscopic content capture in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

Methods, apparatuses, and computer program products are provided in accordance with example embodiments of the present invention to provide personalized stereoscopic content capture.

End users with single camera devices cannot hope to capture stereoscopic content. Embodiments of the present invention facilitate allowing such users at events equipped with types of omnidirectional content capture devices to capture their own stereoscopic content by leveraging the OCC type of devices.

Additionally, end user devices with stereoscopic capture generally have short baselines, and consequently, the range of such systems is limited. Embodiments of the present invention enable capturing stereoscopic content with large baseline.

Embodiments of the present invention enable end users with conventional video capture equipped devices to perform personalized stereoscopic content capture. In an example embodiment, the personalized stereoscopic content capture comprises determining the relative camera pose of the end user device, performing a “buddy” camera selection, and selecting a virtual stereo view.

In an example embodiment, a user starts the stereoscopic content capture client on an end user device, e.g., a mobile device. The 2D video capture is then initiated on the end user device at an event where one or more OCC devices are capturing event content.

The stereoscopic content capture service receives video frames and sensor data associated with the end user device. These video frames and sensor data are used in determining the camera pose estimate (CPE) of the end user device with respect to the one or more OCC devices capturing the event.

The stereoscopic content capture service subsequently selects automatically the best suited “buddy device” from among the one or more OCC devices that are capturing the event. In example embodiments, the selection of the best suited OCC device depends on the user's requirements, which may include the user indicating her requirements implicitly, for example by selecting an object of interest (OOI), or explicitly, for example by indicating the range.

The stereoscopic content capture service calibrates the one or more buddy devices with respect to each other and the end user device via wide-baseline stereo reconstruction and visual positioning. A matching region of interest is extracted from the selected buddy device which corresponds to the end user device captured content. Content capture with the end user device starts and the corresponding virtual stereo view metadata for the buddy device content is generated.

Embodiments of the present invention provide an easy to use stereoscopic content capture functionality to users with conventional video capture devices, enable users to capture stereoscopic content with significantly large baselines, and provide an easy method to end users for capturing personalized stereoscopic content.

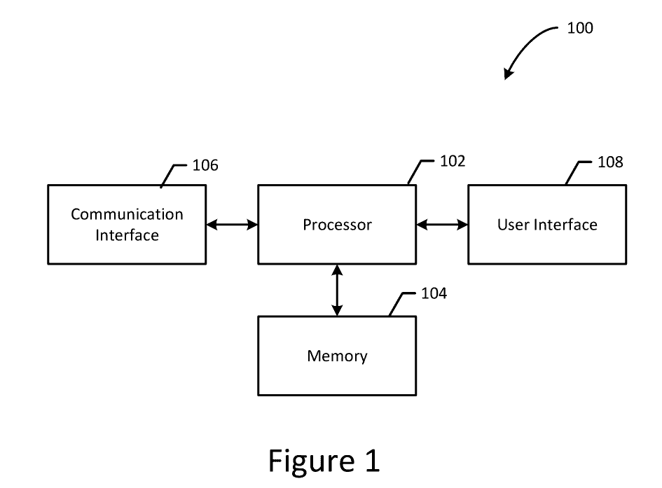

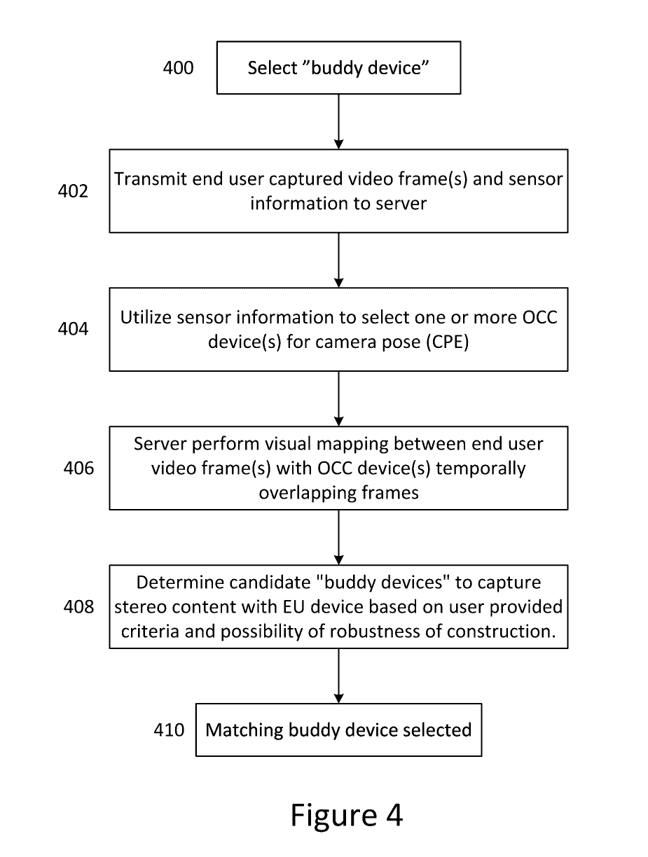

FIG. 1 illustrates an example of an apparatus 100 that may be used in embodiments of the present invention and that may perform one or more of the operations set forth by FIG. 4 described below. In this regard, the apparatus may be embodied by the mobile device 104, end user device 110, or content server 106 of FIG. 1.

It should also be noted that while FIG. 1 illustrates one example of a configuration of an apparatus 100, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring to FIG. 1, the apparatus 100 in accordance with one example embodiment may include or otherwise be in communication with one or more of a processor 102, a memory 102, a communication interface circuitry 106, and user interface circuitry 106.

In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor 102. Additionally or alternatively, the memory device could be configured to store instructions for execution by the processor.

In some embodiments, the apparatus 100 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 102 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 102 may be configured to execute instructions stored in the memory device 104 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 100 may include user interface 108 that may, in turn, be in communication with the processor 102 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

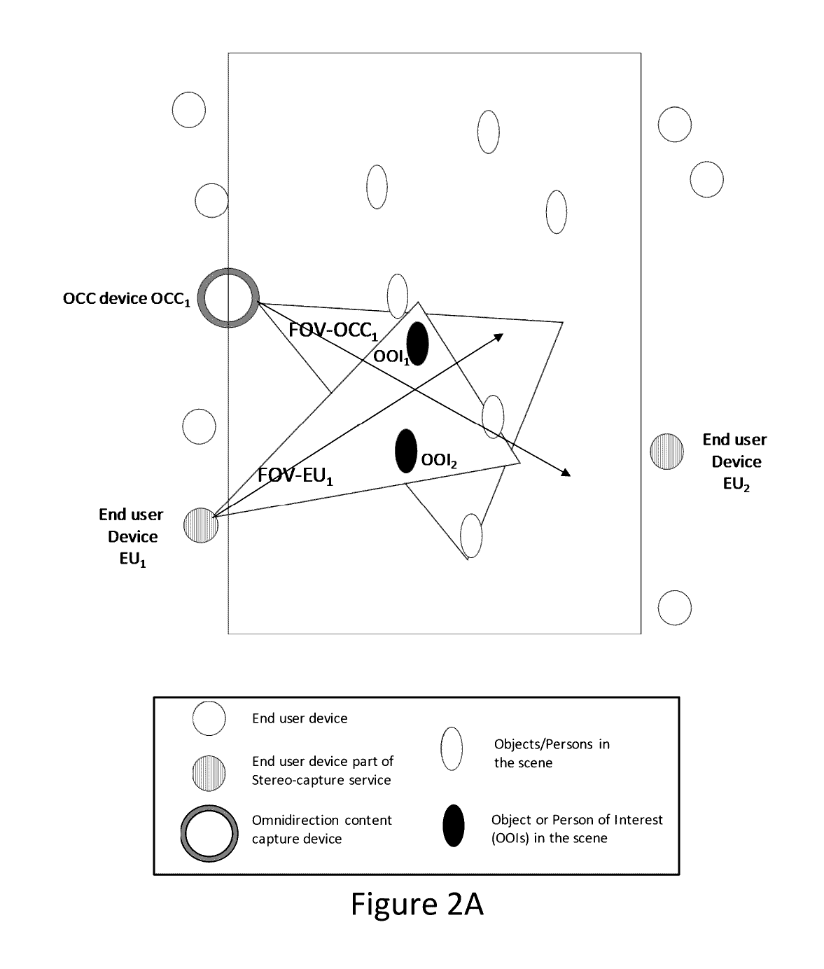

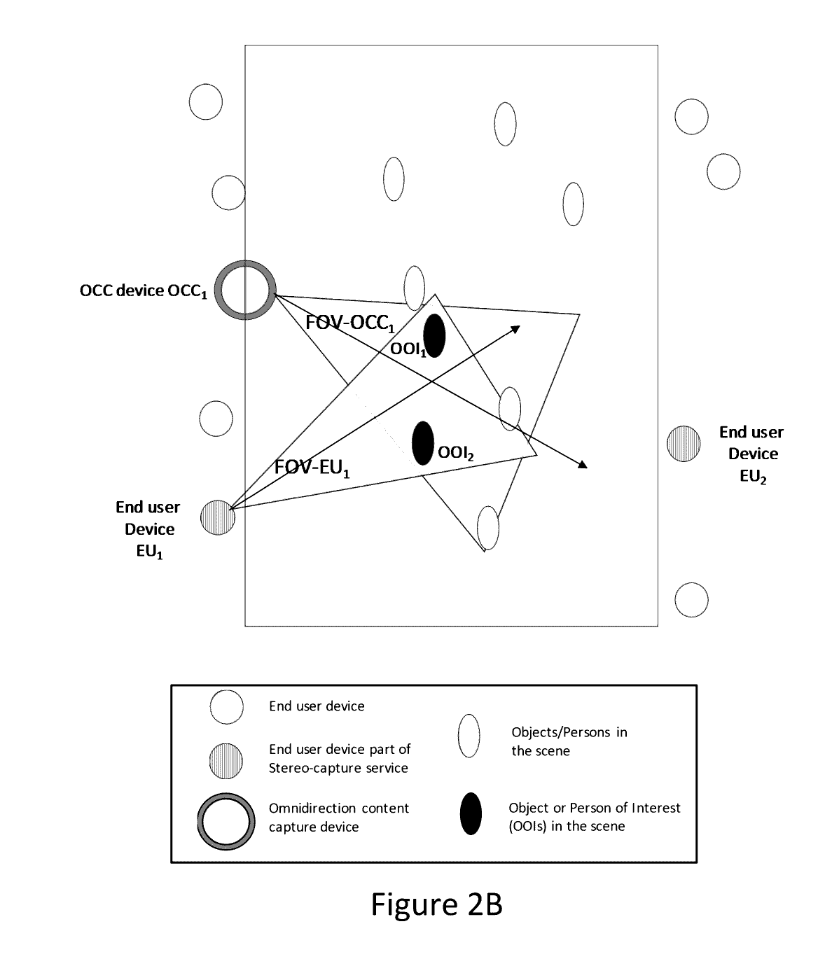

FIGS. 2A and 2B illustrate example embodiments of a stereoscopic content capture system implementation.

FIG. 2A illustrates an example embodiment of a stereoscopic content capture system where a single omnidirectional content capture device is present in the event venue. In FIG. 2A, one OCC device, OCC₁, is in use at an event venue to capture omnidirectional event content. End user devices, EU₁ and EU₂, are conventional content capture end user devices allowing the capture of 2D content. In example embodiments, the end user devices, EU₁ and EU₂, include stereoscopic content capture service clients, allowing the end user devices to collaborate with one or more OCC devices to generate stereoscopic content which matches the end user device content capture.

FIG. 2A illustrates a simplified view of some of the components of a personalized stereoscopic content capture system, which comprises end user devices equipped with a stereoscopic content capture service client, the omnidirectional content capture device which captures the immersive content, for example using OCC devices, and the personalized stereoscopic content capture server which receives data from the end user devices as well as the one or more OCC devices.

FIG. 2B illustrates another example embodiment of a stereoscopic content capture system where multiple omnidirectional content capture devices, OCC₁ and OCC₂, are present in the event venue. An embodiment having multiple OCC devices, as illustrated in FIG. 2B, offers greater flexibility in generating stereoscopic content by providing multiple virtual stereo view choices. This allows capturing stereoscopic content at different depths as well as angle with respect to the end user device position.

Relative Camera Pose Determination

In an example embodiment, such as illustrated in FIG. 2A, when a user at an event venue wishes to capture a stereo version of the content she is able to record with her conventional video capture device (2D video capture); she starts the stereoscopic content capture client on her device, e.g., EU₁. The end user device EU₁ then provides one or more of the following to the stereoscopic content capture system server: one or more video frames, corresponding sensor data (e.g., from GPS/Indoor positioning, compass, accelerometer, gyroscope, or the like), and/or the like. In some embodiments, the end user device may, additionally or alternatively, provide audio data or any suitable temporal synchronization data to the stereoscopic content capture system server.

The stereoscopic content capture system server determines or estimates, based on the sensor information and/or video frames provided by the end user device, the camera pose (CPE) of the end user device with respect to the one or more OCC devices, e.g., OCC₁, capturing the event content.

Buddy Camera Selection

The stereoscopic content capture service subsequently selects, fully automatically, the most suitable “buddy device” (from among the one or more OCC devices) in the event for the end user device. In example embodiments, the determination of the best suited OCC device depends on the user's requirements. In the absence of any indicated user requirements, the service stereoscopic content capture may use default requirements.

In some example embodiments, the user can indicate her requirements implicitly by selecting or pointing out an OOI, for example OOI₁ and/or OOI₂ in FIG. 2A. The OOI information is provided to the stereoscopic content capture server which utilizes this information to determine which OCC device can cover the user selected OOI, for example objects/persons. In some example embodiments, the user can choose to give a high/low/medium range for stereoscopic content capture. For each of the ranges, the corresponding OOIs are indicated to the user, this gives the end user a very intuitive inference of the content capture preference selection.

In example embodiments, default service best buddy device requirements may be provided. For example, in some embodiments, an ideal baseline distance depending on the optical characteristics of the OCC device and the end user device may be used. This may depend on the user's desired focus range: for objects further away, a larger baseline is necessary to achieve sufficient disparity for stereo reconstruction, whereas for nearby objects too much separation makes it difficult to establish correspondence.

In some embodiments, an ideal angle between the end user device and the OCC device may be used. The angle should be as small as possible, as long the baseline requirement is satisfied. Both cameras must see as much of the same side of the object as possible so that 3D matching and reconstruction can be done.

Additionally, in some embodiments, multiple buddy devices may be selected, so that full coverage of the OOI is achieved.

Buddy camera selection for an example embodiment is illustrated in FIG. 4. Buddy device selection begins at block 400, upon the user indicating the desire to generate stereoscopic content (e.g., starting the stereoscopic content capture client on the end user device and initiating content capture by the end user device). At block 402, the end user device, e.g., EU₁, transmits captured video frames and/or sensor data to the stereoscopic content capture system. At block 404, the stereoscopic content capture system uses the received end user device data to determine the CPE for the end user device with respect to the one or more OCC devices at the event.

At block 406, the stereoscopic content capture system performs a visual mapping between one or more end user device video frames with one or more OCC device temporally overlapping video frames. At block 408, the stereoscopic content capture system determines candidate buddy devices from the one or more OCC devices at the event to use in generating stereoscopic content with the end user device. In example embodiments, the candidate buddy device determination may be based on user provided criteria and possibility of robustness of construction. For example, a buddy device may be selected such that a suitable baseline (between the buddy device and the end user device) is achieved for robust stereo reconstruction, e.g., a too narrow or too wide baseline (compared to the distance of the OOI from the baseline) may degrade the quality of the stereo reconstruction.

At block 410, the stereoscopic content capture system selects the buddy device from the candidates for use in generating the stereoscopic content with the end user device.

Virtual Stereo View Selection

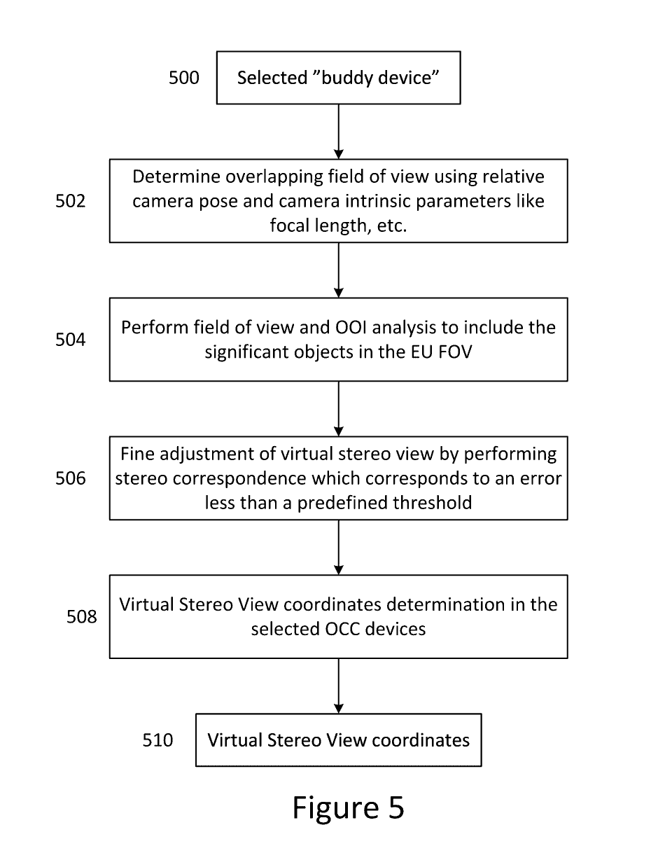

The stereoscopic content capture system calibrates the buddy devices with respect to each other and the end user device via wide-baseline stereo reconstruction and visual positioning. From the selected buddy device, a matching region of interest is extracted which corresponds to the end user device captured content. A part of the 3D scene as reconstructed by the buddy device(s) is extracted and used as the depth map for the virtual stereo view captured with the end user device. The virtual stereo view follows the visual and sensor data received from the end user device. The operations for selecting the coordinates of the virtual stereo view in an example embodiment are illustrated in FIG. 5.

Once the buddy device has been selected, virtual view selection begins at block 500 of FIG. 5. At block 502, the stereoscopic content capture system determines an overlapping field of view between the end user device field of view (e.g., FOV-EU₁ in FIG. 2A) and the OCC device field of view (e.g., FOV-OCC₁ in FIG. 2A). In example embodiments, the overlapping field may be determined by using the relative camera pose of the end user device and intrinsic camera parameters such as focal length and the like.

At block 504, the stereoscopic content capture system performs field of view and OOI analysis to include the significant objects in the end user device field of view (e.g., FOV-EU₁ in FIG. 2A or FOV-EU₂ in FIG. 2B). At block 506, the stereoscopic content capture system may perform fine adjustment of the virtual stereo view by performing stereo correspondence which corresponds to an error less than a predefined threshold. For example, the selected camera content may be cropped such that it corresponds to the end user camera view, in terms of relative OOI position.

At block 508, a determination is made of the virtual stereo view coordinates in the selected buddy device (e.g., OCC₁ of FIG. 2A or OCC₂ of FIG. 2B). At block 510, the virtual stereo view coordinates are provided for use in generating the stereoscopic content for the end user device.

Client Architecture

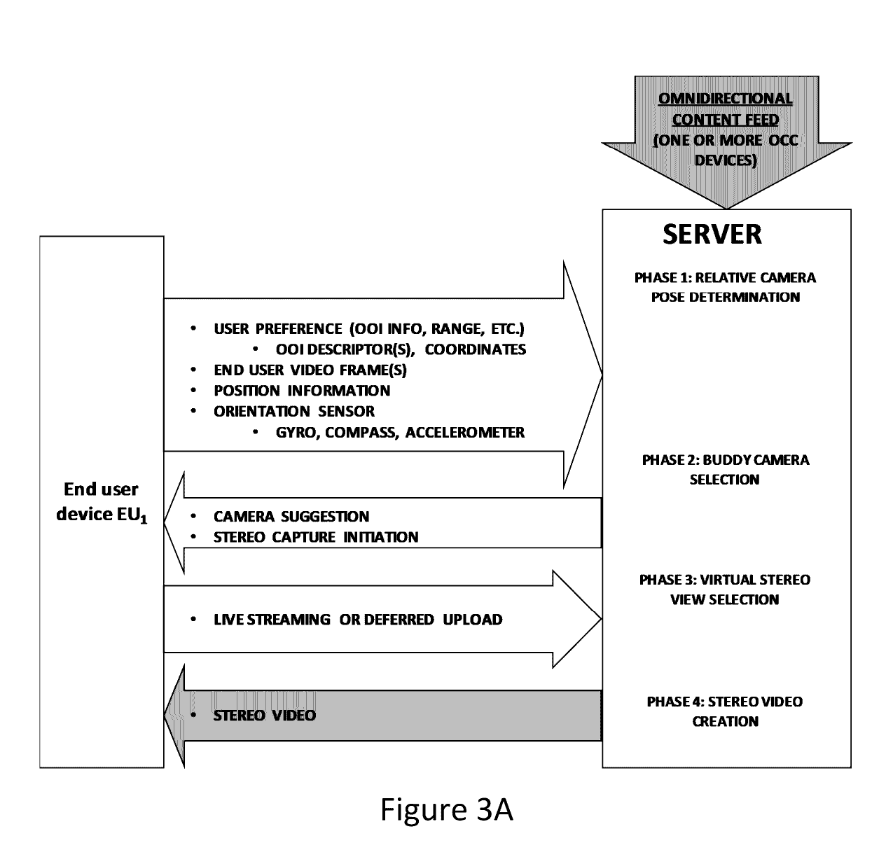

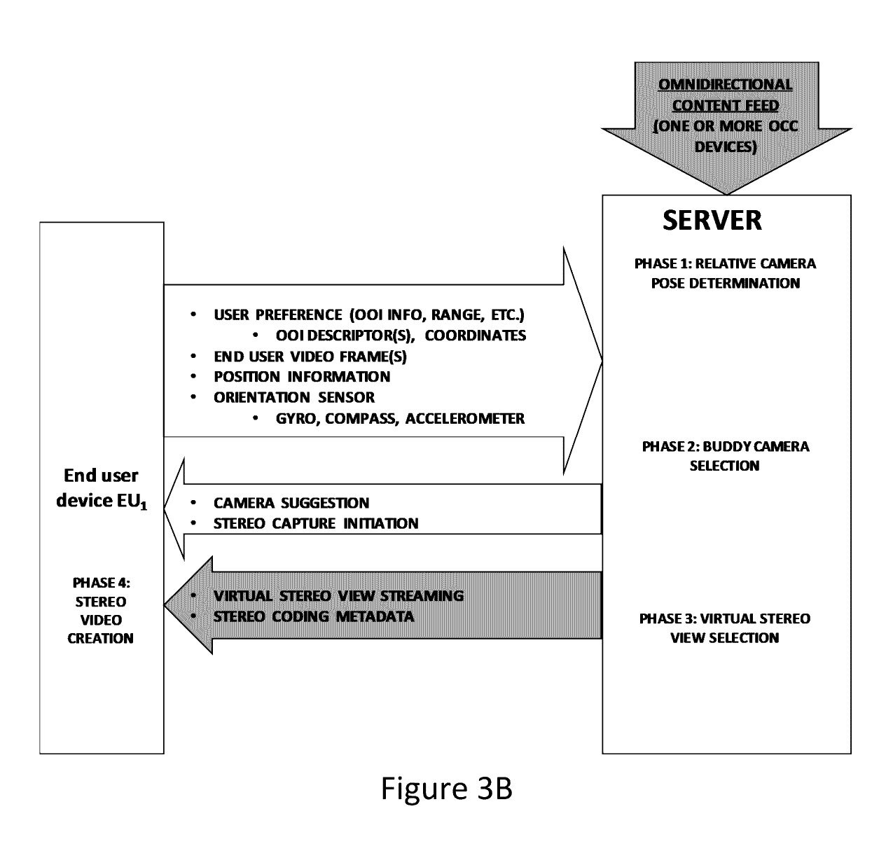

FIG. 3A shows a thin client architecture of an example embodiment which minimizes the processing load on the end user device. In example embodiments, the content recorded by the end user may be transmitted either in real time (live) or uploaded later. In either case, the virtual view selection follows the content recorded by the end user device. The end user captured content and the virtual stereo view content extracted from the OCC device captured content is processed to generate the stereoscopic content.

As illustrated in FIG. 3A, the end user device EU1 provides data to the stereoscopic content capture system, such as user preference data (e.g., OOI data, range data, etc.), one or more end user device captured video frames, position information, orientation sensor data, and/or the like. The stereoscopic content capture system also receives omnidirectional video content feed from one or more OCC capturing event content. The stereoscopic content capture system then performs the relative camera pose determination and buddy device selection; and then provides the camera suggestion the end user device and initiates stereo capture.

The end user device capture the content (e.g., 2D content) and provides the captured content to the stereoscopic content capture system, either in real-time (e.g., streaming) or as a post-capture upload. The stereoscopic content capture system then performs virtual stereo view selection and generates the stereoscopic content, which is then provided to the end user device for viewing.

FIG. 3B shows a thick client architecture of an example embodiment. The thick client architecture minimizes the upload requirements but needs increased download capability as well as increased processing capability on the end user device to generate the stereoscopic content. In the think client architecture illustrated in FIG. 3B, the end user device provides the same type of data to the stereoscopic content capture system, such as user preference data, one or more end user device captured video frames, position information, orientation sensor data, and/or the like. The stereoscopic content capture system also receives omnidirectional video content feed from one or more OCC capturing event content and performs the relative camera pose determination and buddy device selection; and then provides the camera suggestion the end user device and initiates stereo capture. The stereoscopic content capture system also performs the virtual stereo view selection in the thick client embodiment. However, in the thick client embodiment, the stereoscopic content capture system provided virtual stereo view streaming to the end user device, as well as stereo coding metadata. The end user device then performs the stereo view creation for the stereoscopic content.

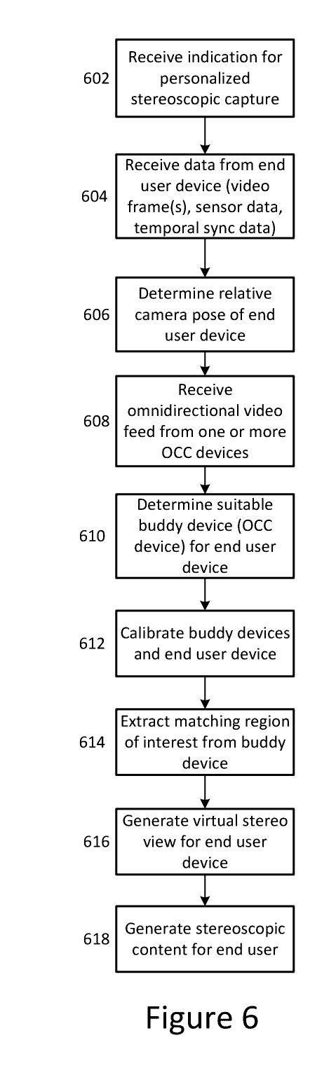

FIG. 6 illustrates a flow chart of example operations for providing personalized stereoscopic content capture in accordance with an example embodiment of the present invention.

In this regard, an apparatus in the stereoscopic content capture system, such as apparatus 100, may include means, such as the processor 102, memory 104, communication interface 106, user interface 108, or the like, for receiving an indication that an end user wishes to capture a stereo version of content, as shown in block 602 of FIG. 6. For example, the user may start a stereoscopic content capture client on her device, which signals the stereoscopic content capture system, and initiate content capture e.g., 2D capture) on her device.

As shown in block 604, the apparatus 100 may include means, such as processor 102, memory 104, communication interface 106, user interface 108, or the like, for receiving end user device data. In example embodiments, the stereoscopic content capture system may receive one or more of: one or more video frames, corresponding sensor data (e.g., GPS/indoor positioning data, compass data, accelerometer data, gyroscope data, or the like), audio data, or any suitable temporal synchronization data from the end user device.

As shown in block 606, the apparatus 100 may also include means, such as the processor 102, memory 104, communication interface 106, user interface 108, or the like, for determining the relative camera pose of the end user device. In example embodiments, the stereoscopic content capture system may determine the end user device camera pose estimate with respect to one or more OCC devices based on the video frames and/or sensor data and/or other data received from the end user device.

At block 608, the apparatus 100 may also include means, such as the processor 102, memory 104, communication interface 106, user interface 108, or the like, for receiving one or more omnidirectional video content feeds from one or more OCC devices. In some embodiments, the stereoscopic content capture system may be receiving one or more omnidirectional video content feeds from one or more OCC devices prior to the indication from the end user device.

As shown in block 610, the apparatus 100 may also include means, such as the processor 102, memory 104, communication interface 106, user interface 108, or the like, for determining a buddy device selection for the end user device, such as described in regard to FIG. 4.

At block 612, the apparatus 100 may also include means, such as the processor 102, memory 104, communication interface 106, user interface 108, or the like, for calibrating the OCC devices with each other and with the end user device.

At block 614, the apparatus 100 may include means, such as the processor 102, memory 104, communication interface 106, user interface 108, or the like, for extracting a matching region of interest from the selected buddy device which corresponds to the end user device captured content.

At block 616, the apparatus 100 may also include means, such as the processor 102, memory 104, communication interface 106, user interface 108, or the like, for generating the virtual stereo view, for example as described in relation to FIG. 5. At block 618, the stereoscopic content may then be generated for the end user device and provided for viewing by the end user.

In some embodiments, certain content capture characteristics of the end user device may be provided for use in generating the artificial depth of field and the personalized content feed at blocks 414 and 416. For example, in some embodiments, settings of the end user device such as hue, exposure, brightness, and or the like, may be provided and used to further personalize the content view.

As described above, FIGS. 4 through 6 illustrate flowcharts of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving data corresponding to content capture from an end user device;
receiving one or more omnidirectional content feeds;
determining, by a processor, a camera pose estimate for the end user device in relation to one or more omnidirectional content capture devices providing the one or more omnidirectional content feeds, based in part on the data corresponding to content capture;
selecting one of the one or more omnidirectional content capture devices as a buddy device for the end user device based at least in part on the camera pose estimate;
extracting, from the selected buddy device content feed, a matching region of interest corresponding to end user device content capture;
selecting a virtual stereo view and generating virtual stereo view metadata based on the extracted matching region of interest; and
generating personalized stereoscopic content for the end user device based on virtual stereo view content from the buddy device and content captured by the end user device.

2. The method of claim 1 wherein the data corresponding to content capture from an end user device comprises one or more of:
one or more video frames;
one or more types of sensor data;
audio data; or
temporal synchronization data.

3. The method of claim 2 wherein the types of sensor data comprise one or more of:
GPS data;
indoor positioning system data;
compass data;
accelerometer data; or
gyroscope data.

4. The method of claim 1 further comprising selecting one of the one or more omnidirectional content capture devices as a buddy device based on one of user requirements or default requirements.

5. The method of claim 4 wherein selecting one of the one or more omnidirectional content capture devices as a buddy device based on user requirements comprises receiving an indication of an object of interest.

6. The method of claim 4 wherein selecting one of the one or more omnidirectional content capture devices as a buddy device based on user requirements comprises receiving an indication of a range for stereoscopic content capture.

7. The method of claim 6 wherein the range for stereoscopic content capture may be a high range, medium range, or low range; and wherein indications of corresponding objects of interest for each range may be provided.

8. The method of claim 4 wherein selecting one of the one or more omnidirectional content capture devices as a buddy device based on default requirements comprises using an ideal baseline distance.

9. The method of claim 4 wherein selecting one of the one or more omnidirectional content capture devices as a buddy device based on default requirements comprises using an ideal angle between the end user device and the omnidirectional content capture device.

10. An apparatus comprising at least one processor and at least one memory including computer program instructions, the at least one memory and the computer program instructions, with the at least one processor, causing the apparatus at least to:
receive data corresponding to content capture from an end user device;
receive one or more omnidirectional content feeds;
determine a camera pose estimate for the end user device in relation to one or more omnidirectional content capture devices providing the one or more omnidirectional content feeds;
select one of the one or more omnidirectional content capture devices as a buddy device for the end user device based at least in part on the camera pose estimate; an artificial depth of field for the content wherein the object of interest is in focus; and
extract, from the selected buddy device content feed, a matching region of interest corresponding to end user device content capture;
select a virtual stereo view and generate virtual stereo view metadata based on the extracted matching region of interest; and
generate personalized stereoscopic content for the end user device based on virtual stereo view content from the buddy device and content captured by the end user device.

11. The apparatus of claim 10 wherein the data corresponding to content capture from an end user device comprises one or more of:
one or more video frames;
one or more types of sensor data;
audio data; or
temporal synchronization data.

12. The apparatus of claim 11 wherein the types of sensor data comprise one or more of:
GPS data;
indoor positioning system data;
compass data;
accelerometer data; or
gyroscope data.

13. The apparatus of claim 10 further comprising the at least one memory and the computer program instructions, with the at least one processor, causing the apparatus at least to select one of the one or more omnidirectional content capture devices as a buddy device based on one of user requirements or default requirements.

14. The apparatus of claim 13 wherein selecting one of the one or more omnidirectional content capture devices as a buddy device based on user requirements comprises receiving an indication of an object of interest.

15. The apparatus of claim 13 wherein selecting one of the one or more omnidirectional content capture devices as a buddy device based on user requirements comprises receiving an indication of a range for stereoscopic content capture.

16. The apparatus of claim 15 wherein the range for stereoscopic content capture may be a high range, medium range, or low range; and wherein indications of corresponding objects of interest for each range may be provided.

17. The apparatus of claim 13 wherein selecting one of the one or more omnidirectional content capture devices as a buddy device based on default requirements comprises using an ideal baseline distance.

18. The apparatus of claim 13 wherein selecting one of the one or more omnidirectional content capture devices as a buddy device based on default requirements comprises using an ideal angle between the end user device and the omnidirectional content capture device.

19. A computer program product comprising at least one non-transitory computer-readable storage medium bearing computer program instructions embodied therein for use with a computer, the computer program instructions comprising program instructions, when executed, causing the computer at least to:
receive data corresponding to content capture from an end user device;
receive one or more omnidirectional content feeds;
determine a camera pose estimate for the end user device in relation to one or more omnidirectional content capture devices providing the one or more omnidirectional content feeds;
select one of the one or more omnidirectional content capture devices as a buddy device for the end user device based at least in part on the camera pose estimate; an artificial depth of field for the content wherein the object of interest is in focus; and
extract, from the selected buddy device content feed, a matching region of interest corresponding to end user device content capture;
select a virtual stereo view and generate virtual stereo view metadata based on the extracted matching region of interest; and
generate personalized stereoscopic content for the end user device based on virtual stereo view content from the buddy device and content captured by the end user device.

20. The computer program product of claim 19 wherein the data corresponding to content capture from an end user device comprises one or more of:
one or more video frames;
one or more types of sensor data;
audio data; or
temporal synchronization data.
